(19) United States
(12) Patent Application Publication
(10) Pub. No.: US 2018/0020405 A1
(43) Pub. Date: Jan. 18, 2018

(54) WAKE-UP PACKET ACKNOWLEDGEMENT PROCEDURE

(71) Applicant: Intel IP Corporation, Santa Clara, CA (US)

(72) Inventors: Po-Kai Huang, West Lafayette, IN (US); Minyoung Park, Portland, OR (US)

(21) Appl. No.: 15/391,611

(22) Filed: Dec. 27, 2016

Related U.S. Application Data
(60) Provisional application No. 62/361,902, filed on Jul. 13, 2016.

(51) Int. Cl. H04W 52/02; H04W 48/16; H04W 4/00; H04W 84/12; H04W 88/02

(52) U.S. Cl. CPC H04W 52/0229; H04W 48/16; H04W 4/008; H04W 88/02; H04W 84/12

(57) ABSTRACT

Embodiments of a LP-WUR (low-power wake-up radio) wake-up packet acknowledgement procedure are generally described herein. A first wireless device encodes for transmission of a wake-up packet of a LP-WUR to a second wireless device, the wake-up packet to wake up a WLAN (wireless local area network) radio of the second wireless device. Upon decoding a response frame from the second wireless device received during a predefined time period: the first wireless device encodes for transmission of a data packet to the WLAN radio of the second wireless device. Upon failing to receive the response frame from the second wireless device during the predefined time period: the first wireless device encodes for retransmission of the wake-up packet to the second wireless device.

### PRIORITY CLAIM

This application claims priority under 35 U.S.C. §119 to U.S. Provisional Patent Application Ser. No. 62/361,902, filed Jul. 13, 2016, and titled, “LOW POWER WAKE UP RECEIVER (LP-WUR) WAKE UP PACKET ACKNOWLEDGEMENT PROCEDURE,” which is incorporated herein by reference in its entirety.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard or the IEEE 802.11ax study group. Some embodiments relate to a low-power wake-up radio (LP-WUR). Some embodiments relate to a wake-up packet acknowledgement procedure.

### BACKGROUND

In recent years, applications have been developed relating to social networking, Internet of Things (IoT), wireless docking, and the like. It may be desirable to design low power solutions that can be always-on. However, constantly providing power to a wireless local area network (WLAN) radio may be expensive in terms of battery life.

### BRIEF DESCRIPTION OF THE DRAWINGS

FIG. 1 is a block diagram of a radio architecture, in accordance with some embodiments;

FIG. 2 illustrates a front-end module circuitry for use in the radio architecture of FIG. 1, in accordance with some embodiments;

FIG. 3 illustrates a radio IC circuitry for use in the radio architecture of FIG. 1, in accordance with some embodiments;

FIG. 4 illustrates a baseband processing circuitry for use in the radio architecture of FIG. 1, in accordance with some embodiments;

FIG. 5 illustrates an example system in which a low-power wake-up radio (LP-WUR) is operated, in accordance with some embodiments;

FIG. 6 illustrates an example flow chart of an example first method for wake-up packet acknowledgement, in accordance with some embodiments;

FIG. 7 illustrates an example flow chart of an example second method for wake-up packet acknowledgement, in accordance with some embodiments;

FIG. 8 illustrates an example flow chart of an example third method for wake-up packet acknowledgement, in accordance with some embodiments; and

FIG. 9 illustrates an example flow chart of an example fourth method for wake-up packet acknowledgement, in accordance with some embodiments.

FIG. 10 illustrates an example flow chart of an example method for interfacing a wake-up radio and a WLAN radio, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

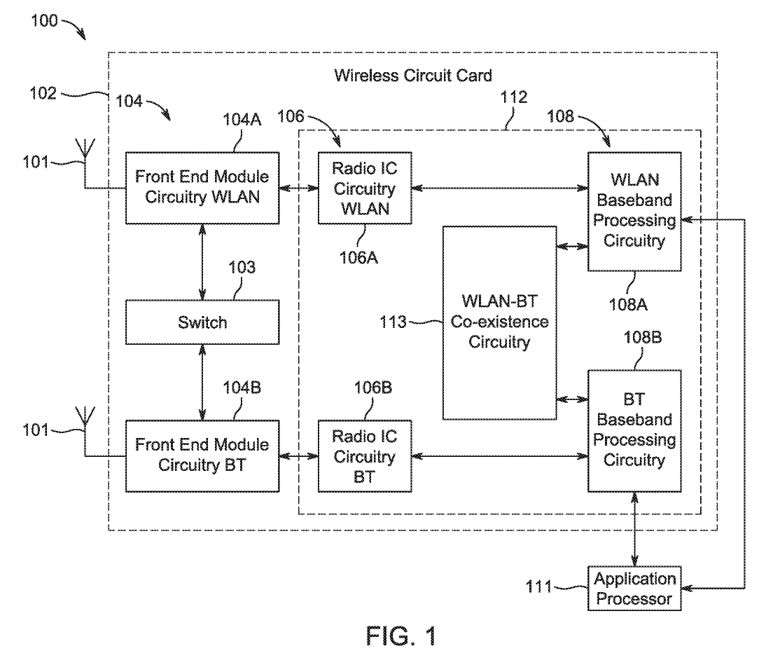

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104a and a Bluetooth (BT) FEM circuitry 104b. The WLAN FEM circuitry 104a may include a receive signal path comprising circuitry configured to operate on WLAN RF signals received from one or more antennas 101, to amplify the received signals and to provide the amplified versions of the received signals to the WLAN radio IC circuitry 106a for further processing. The BT FEM circuitry 104b may include a receive signal path which may include circuitry configured to operate on BT RF signals received from one or more antennas 102, to amplify the received signals and to provide the amplified versions of the received signals to the BT radio IC circuitry 106b for further processing. FEM circuitry 104a may also include a transmit signal path which may include circuitry configured to amplify WLAN signals provided by the radio IC circuitry 106a for wireless transmission by one or more of the antennas 101. In addition, FEM circuitry 104b may also include a transmit signal path which may include circuitry configured to amplify BT signals provided by the radio IC circuitry 106b for wireless transmission by the one or more antennas. In the embodiment of FIG. 1, although FEM 104a and FEM 104b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106a and BT radio IC circuitry 106b. The WLAN radio IC circuitry 106a may include a receive signal path which may include circuitry to down-convert WLAN RF signals received from the FEM circuitry 104a and provide baseband signals to WLAN baseband processing circuitry 108a. BT radio IC circuitry 106b may in turn include a receive signal path which may include circuitry to down-convert BT RF signals received from the FEM circuitry 104b and provide baseband signals to BT baseband processing circuitry 108b. WLAN radio IC circuitry 106a may also include a transmit signal path which may include circuitry to up-convert WLAN baseband signals provided by the WLAN baseband processing circuitry 108a and provide WLAN RF output signals to the FEM circuitry 104a for subsequent wireless transmission by the one or more antennas 101. BT radio IC circuitry 106b may also include a transmit signal path which may include circuitry to up-convert BT baseband signals provided by the BT baseband processing circuitry 108b and provide BT RF output signals to the FEM circuitry 104b for subsequent wireless transmission by the one or more antennas 101. In the embodiment of FIG. 1, although radio IC circuitries 106a and 106b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108a and a BT baseband processing circuitry 108b. The WLAN baseband processing circuitry 108a may include a memory, such as, for example, a set of RAM arrays in a Fast Fourier Transform or Inverse Fast Fourier Transform block (not shown) of the WLAN baseband processing circuitry 108a. Each of the WLAN baseband circuitry 108a and the BT baseband circuitry 108b may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108a and 108b may further include physical layer (PHY) and medium access control layer (MAC) circuitry, and may further interface with application processor 110 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108a and the BT baseband circuitry 108b to enable use cases requiring WLAN and BT coexistence. In addition, a switch 103 may be provided between the WLAN FEM circuitry 104a and the BT FEM circuitry 104b to allow switching between the WLAN and BT radios according to application needs. In addition, although the antennas 101 are depicted as being respectively connected to the WLAN FEM circuitry 104a and the BT FEM circuitry 104b, embodiments include within their scope the sharing of one or more antennas as between the WLAN and BT FEMs, or the provision of more than one antenna connected to each of FEM 104a or 104b.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, 802.11n-2009, IEEE 802.11-2012, 802.11n-2009, 802.11ac, and/or 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108b may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

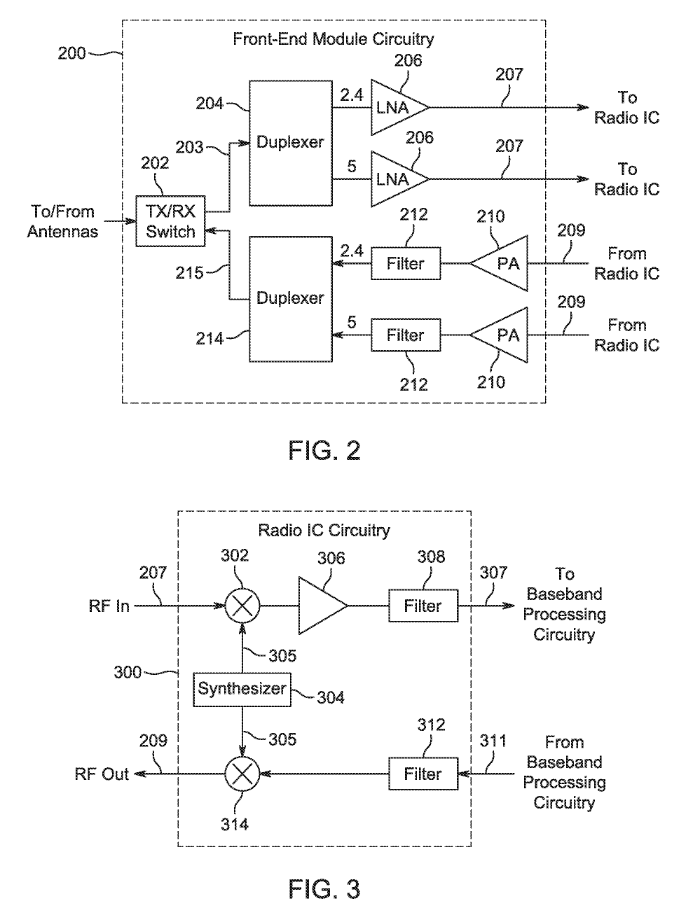

FIG. 2 illustrates FEM circuitry 200 in accordance with some embodiments. The FEM circuitry 200 is one example of circuitry that may be suitable for use as the WLAN and/or BT FEM circuitry 104a/104b (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

FIG. 3 illustrates radio IC circuitry 300 in accordance with some embodiments. The radio IC circuitry 300 is one example of circuitry that may be suitable for use as the WLAN or BT radio IC circuitry 106a/106b (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety degree time-varying LO switching signals provided by a quadrature circuitry which may be configured to receive a LO frequency (fLO) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or the application processor 110 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 110.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (fLO).

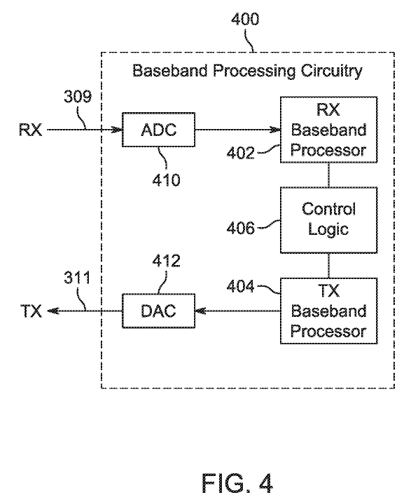

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108a, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

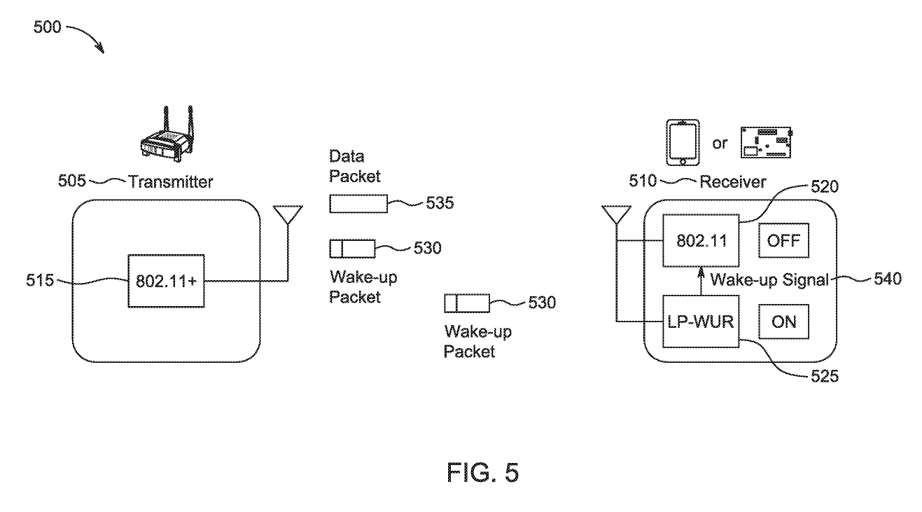

FIG. 5 illustrates an example system 500 in which a low-power wake-up radio (LP-WUR) is operated. As shown, the system 500 includes a transmitter 505 and a receiver 510. The transmitter 505 may be a WLAN station (e.g., Wi-Fi router) and the receiver 510 may be a computing device capable of connecting to the WLAN station, such as a mobile phone, a tablet computer, a laptop computer, a desktop computer, and the like. The transmitter 505 includes an WLAN (802.11+) radio 515. The receiver 510 includes a WLAN (802.11) radio 520 (e.g., Wi-Fi radio) and a LP-WUR 525. The WLAN radio 515 of the transmitter 505 transmits one or more wake-up packets 530. One of the wake-up packets 530 is received at the LP-WUR 525 of the receiver 510. Upon receiving the wake-up packet 530, the LP-WUR 525 sends a wake-up signal 540, which causes the WLAN radio 520 of the receiver 510 to turn on. The WLAN radio 515 of the transmitter 505 transmits data packet(s) 535 to the WLAN radio 520 of the receiver 510, and the WLAN radio 520 of the receiver 510 receives the data packet(s) 535.

As illustrated in FIG. 5, LP-WUR relates to a technique to enable ultra-low power operation for a Wi-Fi device (e.g., receiver 510). The idea is for the device to have a minimum radio configuration (e.g., LP-WUR 525) that can receive a wake-up packet 530 from the peer (e.g., transmitter 505). Hence, the device can stay in low power mode until receiving the wake-up packet 530.

The receiver 510 of the wake-up packet 530 may negotiate with the transmitter 505 of wake-up packet 530 before the receiver 510 enables the LP-WUR mode. Hence, the transmitter 505 knows the agreed bandwidth and channel in which to transmit the wake-up packet, the identification in the wake-up packet, and other related information. In some cases, the transmitter 505 may also send a response frame with information to the receiver 510 before the receiver 510 enables the LP-WUR mode.

The receiver 510 of the wake-up packet 530 may inform the transmitter 505 of wake-up packet 530 before the receiver 510 enables the LP-WUR mode and turns off the WLAN radio 520. Hence, the transmitter 505 knows that wake-up packet 530 is allowed to transmit to the receiver 510. In some cases, the transmitter 505 may also send a response frame with information to the receiver 510 before the receiver 510 enables the LP-WUR mode.

On the other hand, the transmitter 505 may be AP that regulates the power save operation in the base station subsystem (BSS). The receiver 510 may be a sensor, which has simple design and relies on AP to decide the power save mode. As a result, the AP may request the receiver 510 to enable or enable the LP-WUR mode, and the receiver 510 provides a response frame accepting the request.

In some cases, it may take some time (e.g., up to 10 ms) for the receiver 510 of the wake-up packet 530 to wake up the WLAN radio 520 and load the corresponding code to the memory. Hence, the receiver 510 that receives the wake-up packet may not be able to return the acknowledgement with the WLAN radio 520 in short interframe space (SIFS) time, which is the typical procedure to acknowledge WLAN (e.g., 802.11) packets.

Besides the long wake up time, when the receiver 510 finally wakes up, the receiver 510 may also need to wait for network allocation vector (NAV) sync delay and time for contention before transmitting the acknowledgement.

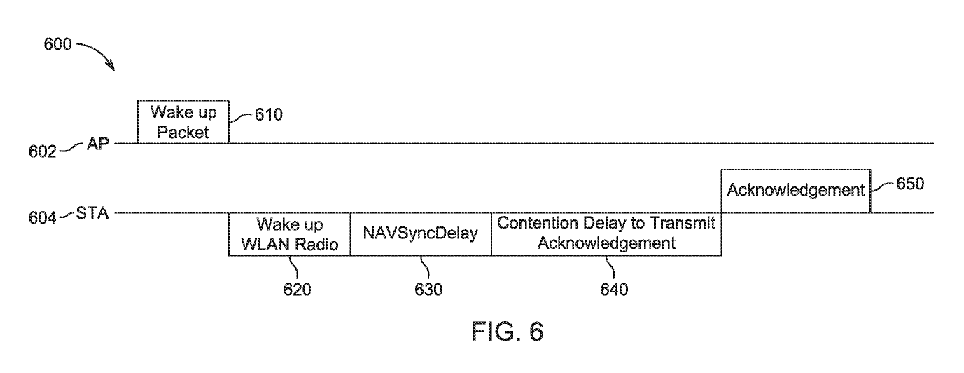

As a result, it may take a long time before the receiver 510 transmits the acknowledgement. Before the receiver 510 transmits the acknowledgement, the transmitter 505 may not know exactly if the receiver 510 has received wake-up packet 530 or not, and the transmitter 505 may keep a long timer to retransmit the wake-up packet 520, which is larger than the sum of the wake-up time plus the NAV sync delay plus the contention delay. The transmitter 505 may also take a long time to retransmit the wake-up packet 530 if the wake-up packet 530 is not correctly received. This increases the delay to wake up the receiver 510 in LP-WUR mode. An example is shown in FIG. 6.

FIG. 6 illustrates an example flow chart of an example first method 600 for wake-up packet acknowledgement, in accordance with some embodiments. The method 600 is implemented with an access point (AP) 602 serving as the transmitter 505, and a station (STA) 604 serving as the receiver 510.

At block 610, the AP 602 transmits the wake-up packet (e.g., wake-up packet 530) to the STA. At block 620, the STA 604 wakes up the WLAN radio in response to the wake-up packet. Block 630 represents NAV sync delay, and block 640 represents the contention delay to transmit the acknowledgement. At block 650, the STA 604 transmits the acknowledgement to the AP 602.

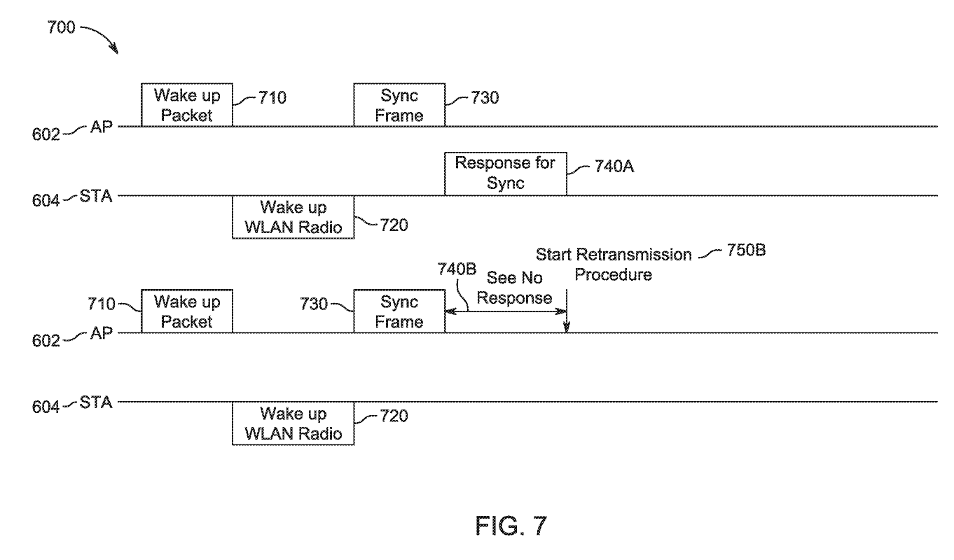

The STA 604 that is changing its WLAN radio from sleep/doze to awake state in order to transmit performs clear channel assessment (CCA) until a frame is detected by which it can set its NAV, or until a period of time indicated by the NAVSyncDelay from the MLME-JOIN.request primitive has transpired, where MLME stands for Media Access Control (MAC) Sublayer Management Entity. In some cases, acknowledgement procedures to shorten the acknowledging time to acknowledge the wake-up packet, relative to that shown in FIG. 6, may be desirable. The embodiments shown in FIGS. 7-9 provide examples of such acknowledgement procedures.

FIG. 7 illustrates an example flow chart of an example second method 700 for wake-up packet acknowledgement, in accordance with some embodiments.

At block 710, the AP 602 sends the wake-up packet to the STA 604. At block 720, the STA 604 wakes up its WLAN radio in response to the wake-up packet. At block 730, after waiting for a time during which the STA 604 is expected to wake up the WLAN radio, the AP 602 sends a sync frame to the STA. In one case, at block 740A, the STA 604 sends to the AP 602 a response for the sync frame, confirming that the WLAN radio was waken up and the sync frame was received. Alternatively, if the AP 602 does not receive or decode a response to the sync frame in the time period represented by block 740B, the AP 602 starts the retransmission procedure of the wake-up packet at block 750B.

The AP 602 transmits the sync frame after the estimated time for the STA 604 to be awake to shorten the time by eliminating the NAV sync delay. Furthermore, any frame transmitted by the WLAN radio of the STA 604 that receives wake-up packet can be treated as an acknowledgement for the wake-up packet. Thus, the sync frame may be any frame that solicits a feedback such as a request to send (RTS), short data, quality of service (QoS) Null, management frame, and the like. As a result, the method 700 shortens the time by eliminating contention delay to transmit acknowledgement.

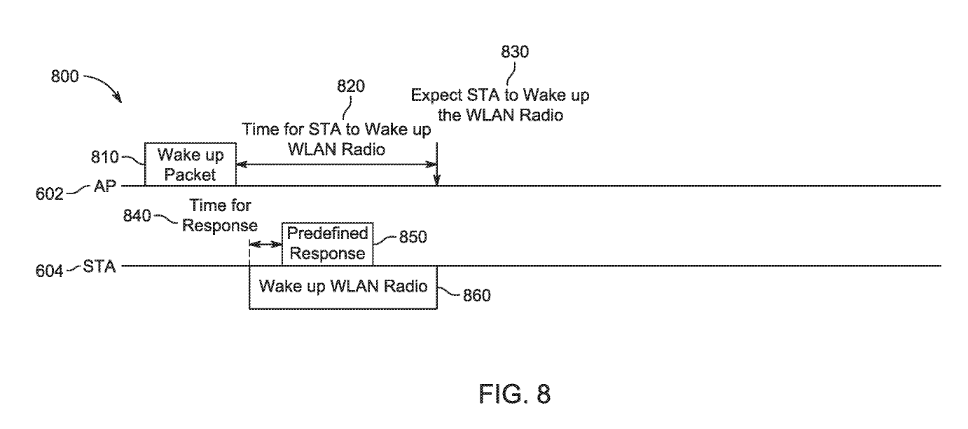

FIG. 8 illustrates an example flow chart of an example third method 800 for wake-up packet acknowledgement, in accordance with some embodiments. In accordance with the method 800, the transmit capability of the LP-WUR of the STA 604 is enabled. Specifically, as described in detail below, a predefined format is stored by the STA 604 in LP-WUR mode, and the STA 604 responds using the predefined format after receiving wake-up packet. As a result, there is no problem of a long waiting time for acknowledgement of the wake-up packet.

At block 810, the AP 602 transmits the wake-up packet to the STA 604. After sending the wake-up packet, the AP 602 waits a time, represented by block 820, for the STA 604 to wake up its WLAN radio. During the time of the block 820, the LP-WUR of the STA 604 takes a time for response, represented by block 840, to generate and transmit a predefined response 850 to the AP 602. The predefined response acknowledges receipt of the wake-up packet. Meanwhile, at block 860, the STA 604 wakes up its WLAN radio. At the end of block 850, the AP 602 expects that the STA 604 has received the wake up packet. At block 830, after waiting the time, represented by block 820, for the STA 604 to wake up its WLAN radio, and receiving the predefined response of block 850, the AP 602 expects that the STA 604 has woken up its WLAN radio.

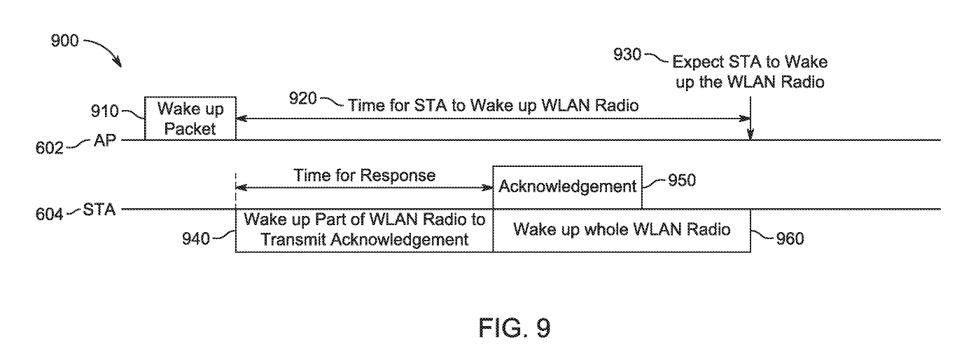

FIG. 9 illustrates an example flow chart of an example fourth method 900 for wake-up packet acknowledgement, in accordance with some embodiments. In accordance with the method 900, a mode of the STA 604 is enabled, where only part of the WLAN radio is activated first to transmit the acknowledgement, then a specific amount of time is waited for the AP 602 transmitting the wake-up packet to transmit data to the STA 604 receiving the wake-up packet. Compared with the method 800, there is no need to build transmit capability into the LP-WUR of the STA 604.

At block 910, the AP 602 transmits the wake-up packet to the STA 604. The AP then waits a time for the STA to wake up the WLAN radio, represented by block 920. Meanwhile, at block 940, the STA 604, in response to the wake-up packet, wakes up a part of the WLAN radio to transmit the acknowledgement of the wake-up packet. After waking up the part of the WLAN radio, at block 950, the STA 604 transmits the acknowledgement to the AP 602. At block 960, the STA 604 wakes up the whole WLAN radio. At the end of block 950, the AP 602 expects that the STA 604 has received the wake-up packet. At block 930, after waiting the time represented by block 920 and receiving the acknowledgement of block 950, the AP 602 expects that the STA 604 has woken up its WLAN radio.

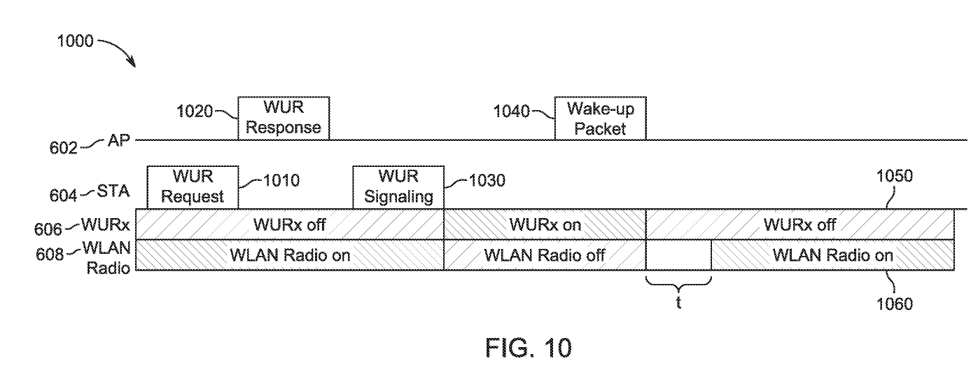

In accordance with the approach of FIG. 7, the AP 602 transmitting the wake-up packet can choose to send a sync frame to shorten the NAV sync delay of the STA 604 that transitions from LP-WUR mode to active mode after receiving the sync frame. The sync frame can be any 802.11 frame, for example, any control frame, data frame, or management frame (e.g., beacon). The sync frame can solicit a response from the device that transitions from LP-WUR mode to active mode. The sync frame that solicits responses may include RTS, short data, QoS Null, or any control frame or management frame. The corresponding response can then include CTS, Ack, Block Ack (BA), data, or any control or management frame. The sync frame may solicit multiple responses simultaneously from multiple devices that transition from LP-WUR mode to active mode. The sync frame that solicits multiple responses may include trigger frame or any trigger frame variant, such as multi-user (MU) block acknowledgement request (BAR), MU-RTS, and the like. The sync frame may be requested by the STA 604. Alternatively, the AP 602 may decide whether to transmit the sync frame. One bit in the WUR request or response from the STA 604 when the STA 604 negotiates WUR transmission parameters with the AP 602 can be used to indicate the request for transmission of the sync frame. An example is described in conjunction with FIG. 10.

Regarding the time to transmit the sync frame, if a wake-up packet indicates a time for the STA 604 to wake up, the sync frame is scheduled to transmit at or after the indicated wake up time. If a wake-up packet does not indicate a time for the STA 604 to wake up, the sync frame is scheduled to transmit at or after time that is the end of wake-up packet transmission plus the required time for the STA 604 to wake up plus the time for the STA 604 to process the wake-up packet. The AP 602 needs to contend for the medium before transmitting the sync frame.

Regarding the retransmission procedure under the sync frame mechanism, if the sync frame is not transmitted, the AP 602 waits for a time to receive an acknowledgement from the STA 604, and if the AP 602 does not receive any response from the STA 604, then the AP 602 starts the retransmission of wake-up packet to the STA 604. The waiting time considers the potential contention delay to transmit acknowledgement and the NAV sync delay. If a wake-up packet does not indicate a time for the STA 604 to wake up, the waiting time starts at the time that is the end of the wake-up packet transmission plus the required time for the STA 604 to wake up plus the time for the STA 604 to process the wake-up packet. If a wake-up packet indicates a time for the STA 604 to wake up, the waiting time starts at the indicated wake up time. If the sync frame is transmitted and the sync frame solicits a response from the STA 604, and the AP 602 does not receive any response from the STA 604, then the AP 602 starts the retransmission of wake-up packet to the STA 604.

If the sync frame is transmitted and the sync frame does not solicit a response from the STA 604, the AP 602 waits for a time to receive acknowledgement from the STA 604. The waiting time starts at the end of the sync frame. If there is no response from the STA 604 within the timer, then the AP 602 starts the retransmission of the wake-up packet to the STA 604. The waiting time is shorter than the waiting time if the AP 602 does not transmit sync frame. The waiting may be based on the potential contention delay to transmit the acknowledgement and, in some cases, is not based on the NAV sync delay. The end of the waiting time is not later than the end of the waiting time under the case where the AP 602 does not transmit the sync frame.

The AP 602 obtains the time for the STA 604 to wake up. In some cases, the time for the STA 604 to wake up is indicated when the STA 604 informs the AP 602 to enter LP-WUR mode. In another case, the time for the STA 604 to wake up is indicated in WUR request or response from the STA 604 when the STA 604 negotiates WUR transmission parameters with the AP 602. An examples is described in conjunction with FIG. 10. The time for the STA 604 to wake up can be an agreed time in a specification.

In accordance with FIG. 8, the STA 604 with LP-WUR is capable of transmitting a response to the AP 602, which transmits the wake-up packet, using the LP-WUR of the STA 604, after receiving the wake-up packet at the STA 604 in LP-WUR mode. The response can be a predefined format, for example, a legacy preamble with a short training field (STF)+long training field (LTF)+legacy signal field (L-SIG). The response is sent after a predefined response time. The predefined response time can be SIFS. Alternatively, the predefined response time can be negotiated between the AP 602 and the STA 604 when the STA 604 informs the AP 602 to enter LP-WUR mode. In another case, the predefined response time for the STA 604 is indicated in WUR request or response from the STA 604 when the STA 604 negotiates WUR transmission parameters with the AP 602. An example is described in conjunction with FIG. 10. The AP 602 transmits data to the STA 604 after the STA 604 wakes up the whole WLAN (e.g., 802.11) radio.

Aspects of the subject technology relate to a retransmission procedure under the response to the wake-up packet mechanism. For example, the AP 602 retransmits the wake-up packet to the STA 604 if the AP 602 does not receive the response in a predetermined time.

The example of FIG. 9 relates to the STA 604 with LP-WUR being capable of transmitting a response to the AP 602, which transmits wake-up packet, with its WLAN radio after receiving the wake-up packet in LP-WUR mode. In some cases, the STA 604 wakes up a part of the WLAN radio, rather than the whole WLAN radio, to transmit the response. The response may be an acknowledgement (ACK) frame. The response may be sent after a predefined response time. The predefined response time can be SIFS. The predefined response time can be negotiated between the AP 602 and the STA 604 when the STA 604 informs the AP 602 to enter LP-WUR mode. In another case, the predefined response time for the STA 604 is indicated in WUR request or response from the STA 604 when the STA 604 negotiates WUR transmission parameters with the AP 602. An example is described in conjunction with FIG. 10. The AP 602 transmits data to the STA 604 after the STA 604 wakes up the whole WLAN radio.

According to the retransmission procedure under the response to wake-up packet mechanism, the AP 602 retransmits the wake-up packet to the STA 604 if the AP 602 does not receive the response in a predetermined time.

According to some aspects of the subject technology, there are responses from a STA after transmitting a wake-up packet to the STA. According to some aspects of the subject technology, an AP schedules a sync frame to transmit after the AP transmits a wake-up packet.

FIG. 10 illustrates an example flow chart of an example method 1000 for interfacing a wake-up radio and a WLAN radio, in accordance with some embodiments. The method 1000 is implemented with the AP 602 and the STA 604. The STA 604 has a wake-up radio (WURx) 606 and a WLAN radio 608.

At block 1010, the STA 604 sends, to the AP 602, a WUR request while the WLAN radio 608 is on and the WURx 606 is off. At block 1020, the AP 602 sends, to the STA 604, a WUR response. At block 1030, the STA 604 sends, to the AP 602, WUR signaling. The WUR signaling informs the AP 602 that the STA 604 is entering the WUR state. After block 1030, the STA 604 turns the WURx 606 on and turns the WLAN radio 608 off. At block 1040, the AP 602 sends, to the STA 604, a wake-up packet. At block 1050, the WURx 606 of the STA 604 is turned off. A time period t later, after processing the wake-up packet of block 1040, at block 1060, the WLAN radio 608 of the STA 604 is turned on.

Aspects of the subject technology are described below using various examples.

Example 1 is an apparatus of a first wireless device, the apparatus comprising: memory; and processing circuitry, the processing circuitry to: encode for transmission of a wake-up packet of a LP-WUR (low-power wake-up radio) to a second wireless device, the wake-up packet to wake up a WLAN (wireless local area network) radio of the second wireless device; upon decoding a response frame from the second wireless device received during a predefined time period, the predefined time period occurring after the transmission of the wake-up packet and when the WLAN radio of the second wireless device is predicted to be turned on, the response frame indicating that the WLAN radio of the second wireless device is turned on: encode for transmission of a data packet to the WLAN radio of the second wireless device; and upon failing to receive the response frame from the second wireless device during the predefined time period: encode for retransmission of the wake-up packet to the second wireless device.

Example 2 is the apparatus of example 1, wherein the first wireless device comprises an access point (AP) and the second wireless device comprises a station (STA).

Example 3 is the apparatus of example 1, wherein the processing circuitry is further to: encode for transmission, a first time period after transmitting the wake-up packet, of a sync frame to the second wireless device, wherein the response frame is responsive to the sync frame, and wherein the predefined time period is determined based on the first time period.

Example 4 is the apparatus of example 3, wherein the sync frame comprises one: of a control frame, a data frame, and a management frame.

Example 5 is the apparatus of example 3, wherein the response frame, responsive to the sync frame, comprises a control frame.

Example 6 is the apparatus of example 5, wherein the control frame comprises an ACK (acknowledgement frame), a BA (block acknowledgement frame), or a CTS (clear to send frame).

Example 7 is the apparatus of example 1, wherein the wake-up packet indicates a time to wake up the WLAN radio of the second wireless device, and wherein the predefined time period is determined based on the time to wake up the WLAN radio of the second wireless device.

Example 8 is the apparatus of example 1, wherein the wake-up packet does not indicate when to wake up the WLAN radio of the second wireless device, and wherein the predefined time period is determined based on an amount of time for the second wireless device to process the wake-up packet and an amount of time to wake up the WLAN radio of second wireless device.

Example 9 is the apparatus of example 1, wherein the predefined time period is determined based on a NAVSyncDelay (network allocation vector sync delay).

Example 10 is the apparatus of example 1, further comprising transceiver circuitry to: transmit the wake-up packet.

Example 11 is the apparatus of example 10, further comprising an antenna coupled to the transceiver circuitry.

Example 12 is an apparatus of a first wireless device, the apparatus comprising: memory; and processing circuitry, the processing circuitry to: decode a wake-up packet, the wake-up packet being received at a LP-WUR (low-power wake-up radio) and from a second wireless device; turn on a first component of a WLAN (wireless local area network) radio of the first wireless device in response to the wake-up packet; encode an acknowledgement frame for transmission to the second wireless device using the first component of the WLAN radio, the acknowledgement frame being responsive to the wake-up packet; turn on one or more additional components of the WLAN (wireless local area network) radio in response to the wake-up packet; decode a data packet, the data packet being received using the WLAN radio.

Example 13 is the apparatus of example 12, wherein the first wireless device comprises a station (STA) and the second wireless device comprises an access point (AP).

Example 14 is the apparatus of example 12, wherein the one or more additional components are turned on after transmission of the acknowledgement frame.

Example 15 is the apparatus of example 12, wherein the processing circuitry is to encode the acknowledgement frame for transmission a predetermined response time after decoding the wake-up packet.

Example 16 is the apparatus of example 15, wherein the predetermined response time is SIFS (short interframe space).

Example 17 is a non-transitory machine-readable medium storing instructions for execution by processing circuitry of a first wireless device, the instructions causing the processing circuitry to: encode for transmission of a wake-up packet of a LP-WUR (low-power wake-up radio) to a second wireless device, the wake-up packet to wake up a WLAN (wireless local area network) radio of the second wireless device; upon decoding a response frame received from the second wireless device during a predefined time period, the predefined time period occurring after the transmission of the wake-up packet and when the WLAN radio of the second wireless device is predicted to be turned on, the response frame indicating that the WLAN radio of the second wireless device is turned on: encode for transmission of a data packet to the WLAN radio of the second wireless device; and upon failing to receive the response frame from the second wireless device during the predefined time period: encode for retransmission of the wake-up packet to the second wireless device.

Example 18 is the machine-readable medium of example 17, wherein the first wireless device comprises an access point (AP) and the second wireless device comprises a station (STA).

Example 19 is the machine-readable medium of example 17, wherein the processing circuitry is further to: encode for transmission, a first time period after transmitting the wake-up packet, of a sync frame to the second wireless device, wherein the response frame is responsive to the sync frame, and wherein the predefined time period is determined based on the first time period.

Example 20 is a method, implemented at a first wireless device, the method comprising: encoding for transmission of a wake-up packet of a LP-WUR (low-power wake-up radio) to a second wireless device, the wake-up packet to wake up a WLAN (wireless local area network) radio of the second wireless device; upon decoding a response frame received from the second wireless device during a predefined time period, the predefined time period occurring after the transmission of the wake-up packet when the WLAN radio of the second wireless device is predicted to be turned on, the response frame indicating that the WLAN radio of the second wireless device is turned on: encoding for transmission of a data packet to the WLAN radio of the second wireless device; and upon failing to receive the response frame from the second wireless device during the predefined time period: encoding for retransmission of the wake-up packet to the second wireless device.

Example 21 is the method of example 20, wherein the wake-up packet indicates a time to wake up the WLAN radio of the second wireless device, and wherein the predefined time period is determined based on the time to wake up the WLAN radio of the second wireless device.

Example 22 is the method of example 20, wherein the wake-up packet does not indicate when to wake up the WLAN radio of the second wireless device, and wherein the predefined time period is determined based on an amount of time for the second wireless device to process the wake-up packet and an amount of time to wake up the WLAN radio of second wireless device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a first wireless device, the apparatus comprising:
memory; and processing circuitry, the processing circuitry to:
encode for transmission of a wake-up packet of a LP-WUR (low-power wake-up radio) to a second wireless device, the wake-up packet to wake up a WLAN (wireless local area network) radio of the second wireless device;
upon decoding a response frame from the second wireless device received during a predefined time period, the predefined time period occurring after the transmission of the wake-up packet and when the WLAN radio of the second wireless device is predicted to be turned on, the response frame indicating that the WLAN radio of the second wireless device is turned on: encode for transmission of a data packet to the WLAN radio of the second wireless device; and
upon failing to receive the response frame from the second wireless device during the predefined time period: encode for retransmission of the wake-up packet to the second wireless device.

2. The apparatus of claim 1, wherein the first wireless device comprises an access point (AP) and the second wireless device comprises a station (STA).

3. The apparatus of claim 1, wherein the processing circuitry is further to:
encode for transmission, a first time period after transmitting the wake-up packet, of a sync frame to the second wireless device, wherein the response frame is responsive to the sync frame, and wherein the predefined time period is determined based on the first time period.

4. The apparatus of claim 3, wherein the sync frame comprises one: of a control frame, a data frame, and a management frame.

5. The apparatus of claim 3, wherein the response frame, responsive to the sync frame, comprises a control frame.

6. The apparatus of claim 5, wherein the control frame comprises an ACK (acknowledgement frame), a BA (block acknowledgement frame), or a CTS (clear to send frame).

7. The apparatus of claim 1, wherein the wake-up packet indicates a time to wake up the WLAN radio of the second wireless device, and wherein the predefined time period is determined based on the time to wake up the WLAN radio of the second wireless device.

8. The apparatus of claim 1, wherein the wake-up packet does not indicate when to wake up the WLAN radio of the second wireless device, and wherein the predefined time period is determined based on an amount of time for the second wireless device to process the wake-up packet and an amount of time to wake up the WLAN radio of second wireless device.

9. The apparatus of claim 1, wherein the predefined time period is determined based on a NAVSyncDelay (network allocation vector sync delay).

10. The apparatus of claim 1, further comprising transceiver circuitry to:
transmit the wake-up packet.

11. The apparatus of claim 10, further comprising an antenna coupled to the transceiver circuitry.

12. An apparatus of a first wireless device, the apparatus comprising:
memory; and processing circuitry, the processing circuitry to:
decode a wake-up packet, the wake-up packet being received at a LP-WUR (low-power wake-up radio) and from a second wireless device;
turn on a first component of a WLAN (wireless local area network) radio of the first wireless device in response to the wake-up packet;
encode an acknowledgement frame for transmission to the second wireless device using the first component of the WLAN radio, the acknowledgement frame being responsive to the wake-up packet;
turn on one or more additional components of the WLAN (wireless local area network) radio in response to the wake-up packet;
decode a data packet, the data packet being received using the WLAN radio.

13. The apparatus of claim 12, wherein the first wireless device comprises a station (STA) and the second wireless device comprises an access point (AP).

14. The apparatus of claim 12, wherein the one or more additional components are turned on after transmission of the acknowledgement frame.

15. The apparatus of claim 12, wherein the processing circuitry is to encode the acknowledgement frame for transmission a predetermined response time after decoding the wake-up packet.

16. The apparatus of claim 15, wherein the predetermined response time is SIFS (short interframe space).

17. A non-transitory machine-readable medium storing instructions for execution by processing circuitry of a first wireless device, the instructions causing the processing circuitry to:
encode for transmission of a wake-up packet of a LP-WUR (low-power wake-up radio) to a second wireless device, the wake-up packet to wake up a WLAN (wireless local area network) radio of the second wireless device;
upon decoding a response frame received from the second wireless device during a predefined time period, the predefined time period occurring after the transmission of the wake-up packet and when the WLAN radio of the second wireless device is predicted to be turned on, the response frame indicating that the WLAN radio of the second wireless device is turned on: encode for transmission of a data packet to the WLAN radio of the second wireless device; and
upon failing to receive the response frame from the second wireless device during the predefined time period: encode for retransmission of the wake-up packet to the second wireless device.

18. The machine-readable medium of claim 17, wherein the first wireless device comprises an access point (AP) and the second wireless device comprises a station (STA).

19. The machine-readable medium of claim 17, wherein the processing circuitry is further to:
encode for transmission, a first time period after transmitting the wake-up packet, of a sync frame to the second wireless device, wherein the response frame is responsive to the sync frame, and wherein the predefined time period is determined based on the first time period.

20. A method, implemented at a first wireless device, the method comprising:
encoding for transmission of a wake-up packet of a LP-WUR (low-power wake-up radio) to a second wireless device, the wake-up packet to wake up a WLAN (wireless local area network) radio of the second wireless device;
upon decoding a response frame received from the second wireless device during a predefined time period, the predefined time period occurring after the transmission of the wake-up packet when the WLAN radio of the second wireless device is predicted to be turned on, the response frame indicating that the WLAN radio of the second wireless device is turned on: encoding for transmission of a data packet to the WLAN radio of the second wireless device; and
upon failing to receive the response frame from the second wireless device during the predefined time period: encoding for retransmission of the wake-up packet to the second wireless device.

21. The method of claim 20, wherein the wake-up packet indicates a time to wake up the WLAN radio of the second wireless device, and wherein the predefined time period is determined based on the time to wake up the WLAN radio of the second wireless device.

22. The method of claim 20, wherein the wake-up packet does not indicate when to wake up the WLAN radio of the second wireless device, and wherein the predefined time period is determined based on an amount of time for the second wireless device to process the wake-up packet and an amount of time to wake up the WLAN radio of second wireless device.
